(19) United States
(12) Patent Application Publication
(10) Pub. No.: US 2004/0236953 A1
(43) Pub. Date: Nov. 25, 2004

(54) Method and device for transmitting an electronic message

(76) Inventors: Olivier Merenne, Brussels (BE); Sebastien Lemmens, Brussels (BE)

Correspondence Address: SUGHRUE MION, PLLC, 2100 PENNSYLVANIA AVENUE, N.W., SUITE 800, WASHINGTON, DC, 20037, US

(21) Appl. No.: 10/477,991

(22) PCT Filed: May 15, 2002
(86) PCT No.: PCT/BE02/00077

(30) Foreign Application Priority Data
May 15, 2001 (EP) 01000144.4

(51) Int. Cl. H04K 1/00

(52) U.S. Cl. 713/182; 713/201

(57) ABSTRACT

A method for transmitting an electronic message from a sender node to at least one receiver node,—forming an electronic message at said sender node;—adding an attribute to said electronic message;—sending said electronic message from said sender node to a first server;—processing said electronic message in order to form a processed electronic message;—transmitting said processed electronic message to said receiver node(s);—said processing comprises a processing by said first server which has a master-slave configuration and comprises a set of slave servers, each slave server being provided for processing a predetermined attribute to said electronic message, and wherein adding said attribute comprises a selection of at least one attribute identifier among series of attribute identifiers, each attribute identifier of said series being associated with one of said slave servers, and wherein said processing comprises: (i) an identifying step comprising; identifying among said set of slave servers, by said master server and based on said attribute identifier, this or those slave server(s) to which said electronic message will be sent in order to be processed; and (ii) a handling step comprising: (ii-1) transmitting said electronic message from said master server to said identified slave server(s); (ii-2) processing said electronic message by each of said identified slave servers in order to incorporate said attribute into said electronic message; (ii-3) transmitting said processed electronic message from the slave server to the master server.

The invention relates to a method for transmitting an electronic message from a sender node to at least one receiver node, said method comprising:

forming an electronic message at said sender node;

adding an attribute to said electronic message;

sending said electronic message from said sender node to a first server;

processing said electronic message in order to form a processed electronic message and transmitting said processed electronic message to said receiver node(s).

Such a method is generally used in networks. One of the most widespread uses of these networks is for exchanging electronic messages. Any computer user operating within such a network, can communicate with possibly millions of other users. However, most standard systems for Electronic Message exchange are very rough regarding the guaranteed quality of service. Among other things, return receipt is sparsely supported, and almost never enforced. Confidentiality is at the most guaranteed in very limited cases, furthermore time stamping, virus prevention and backup services are rather nearly unexistent.

Hence, the last years have seen the emergence of a plurality of methods and devices which add values to existing electronic message systems, while providing some services. Still, it is the responsibility of each user to choose a provider on which to rely for each desired service. Some services require that both the sender and the receiver use the same software and/or hardware and/or subscribe to the same service provider, which makes it impossible for a given user to rely on such services, for sending an electronic message to another user who does not rely on the same service. Moreover, when a user wants to rely on multiple services, he has to make his way through the diversity of protocols and user interfaces, and take into account possible incompatibilities among protocols. In fact, encryption methods used in most security services make it almost impossible to combine such security services, since the content of an encrypted message cannot be processed as such by any other service.

It is an object of the present invention to provide a method and a device for transmitting an electronic message from a sender node, to at least one receiver node which allows a sender to select among a series of services, some services enabling to integrate each time an attribute in the electronic message to be sent.

The method according to the present invention is therefore characterized in that said processing comprises a processing by said first server which has a master-slave configuration and comprises a set of slave servers, each slave server being provided for processing a predetermined attribute to said electronic message, and wherein adding said attribute comprises a selection of at least one attribute identifier among a series of attribute identifiers, each attribute identifier of said series being associated with one of said slave servers, and wherein said processing comprises:

an identifying step comprising:

(i) identifying among said set of slave servers, by said master server and based on said attribute identifier, this or those slave server(s) to which said electronic message will be sent in order to be processed; and

an handling step comprising:

(ii-1) transmitting said electronic message from said master server to said identified slave server(s)

(ii-2) processing said electronic message by each of said identified slave servers in order to incorporate said attribute into said electronic message; and

(ii-3) transmitting said processed electronic message from the slave server to the master server.

So, the person sending the message selects among a series of attribute identifiers at least one attribute identifier corresponding to the attribute the person wants to insert into the electronic message. The master server reads the selected attribute(s) and then identifies among the set of slave servers, the slave server(s) capable to incorporate the selected attribute into the electronic message. Thereafter, the master server transmits the electronic message to the identified slave server. The identified slave server incorporates the attribute into the electronic message, and returns the processed electronic message to the master server. So, the electronic message will pass into all the identified slave servers, one after another, in order to incorporate all the selected attributes. Moreover, the electronic message can also be transmitted directly from a selected slave to another selected slave server without transmitting via the master server.

Therefore, the person sending his electronic message can incorporate simultaneously a series of attributes into his electronic message in order to, for example, protect his electronic message against viruses, encrypt his electronic message with a public key and have his electronic message stamped by a third party. In such a manner, the electronic message will flow in each slave server selected by the first server.

A second preferred embodiment of a method according to the present invention is characterized in that said sender and receiver node are operating within a network comprising at least one further node to which a further server having a master-slave configuration is connected, and wherein said identifying step comprises: verifying for each attribute identifier, by said first master server whether there is among the slave server(s) associated with the first server, a slave server able to incorporate said attribute into said electronic message; searching, if said first server establishes that it lacks an associated slave server able to incorporate said attribute into said electronic message, among said further server(s), if one of them has at least one slave server(s) able to incorporate said attribute into said electronic message; upon finding among said further server(s), a dedicated further server able to incorporate said attribute into said electronic message; transmitting, by said first server to said dedicated further server; processing said electronic message by said slave server in order to incorporate said attribute into said electronic message; and if upon said searching, said first server doesn't find among said further server(s), any further server able to incorporate said attribute into said electronic message, generating a first error message, by said first server.

Therefore, if the first server has no associated slave server for processing the selected attributes, the first server will search on the network if there is another slave server which is able to incorporate the selected attribute into the electronic message. When the first server has found a slave server able to incorporate the selected attribute, he will transmit the electronic message to that slave server which can process then the electronic message. The processing capability can in such a manner be shared over the network which enables a large capability for processing attribute identifiers.

A third embodiment of a method according to the present invention is characterised in that after transmitting said electronic message to said receiver node, said electronic message is received and handled further by said receiver node having a receiver server with a master-slave configuration. This embodiment allows when the electronic message arrives at the receiver node(s), to be handled in an analogous manner as at the sender node.

According the present invention, the notion of Electronic Message (EM) is intended to cover any kind of digital information, either composed of one or multiple parts, encrypted or not, emitted from what will be further referred to as a sender, prepared in a specific format to be transferred through an Electronic Message Transfer System (EMTS), and destined to what will be referred to as a receiver.

The invention also relates to a device for transmitting an electronic message from a sender node to at least one receiver node.

The invention will nowbe described hereinafter in more detail and by way of example with reference to the appended drawings.

In the drawings:

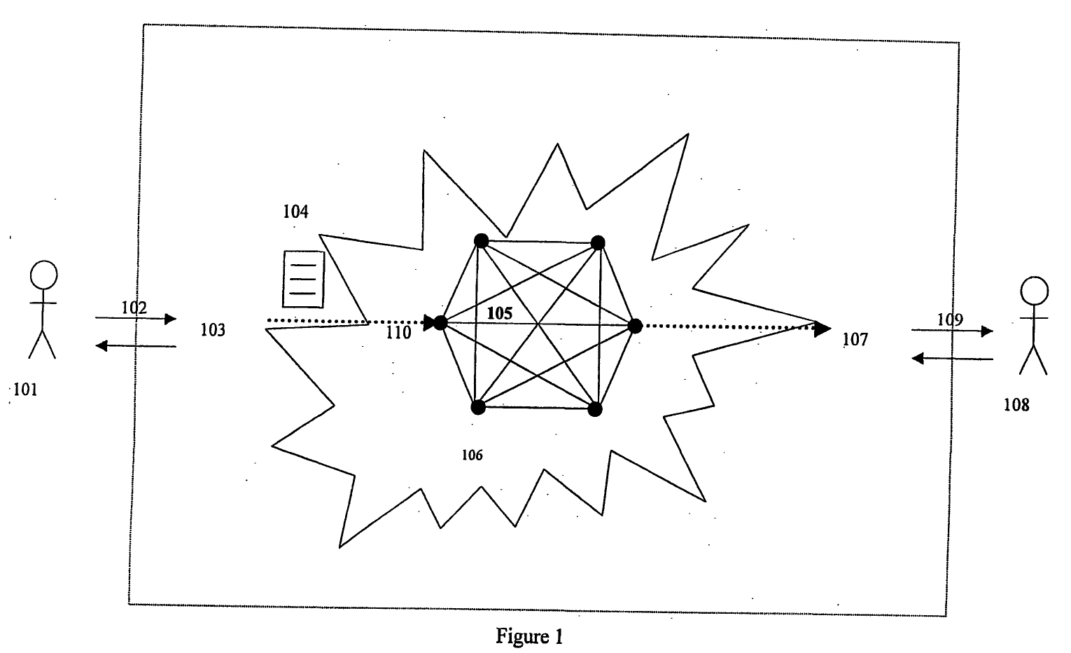

FIG. 1 shows schematically a method for transmitting an electronic message according the state of art;

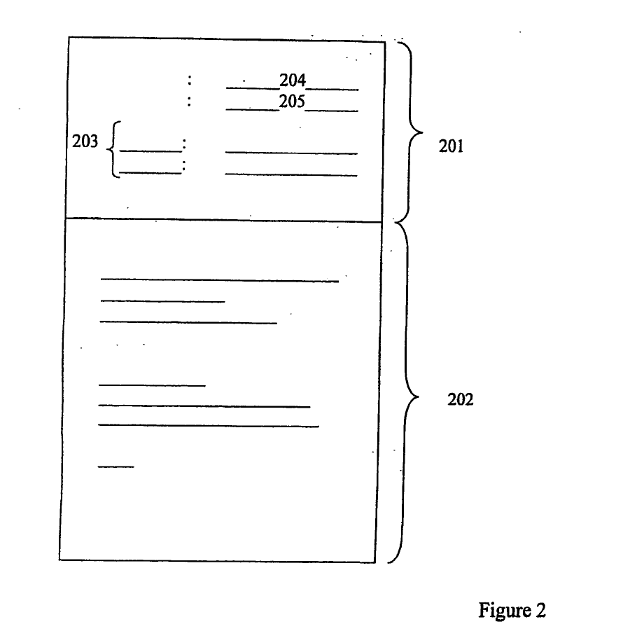

FIG. 2 shows schematically a method for transmitting an electronic message according the present invention;

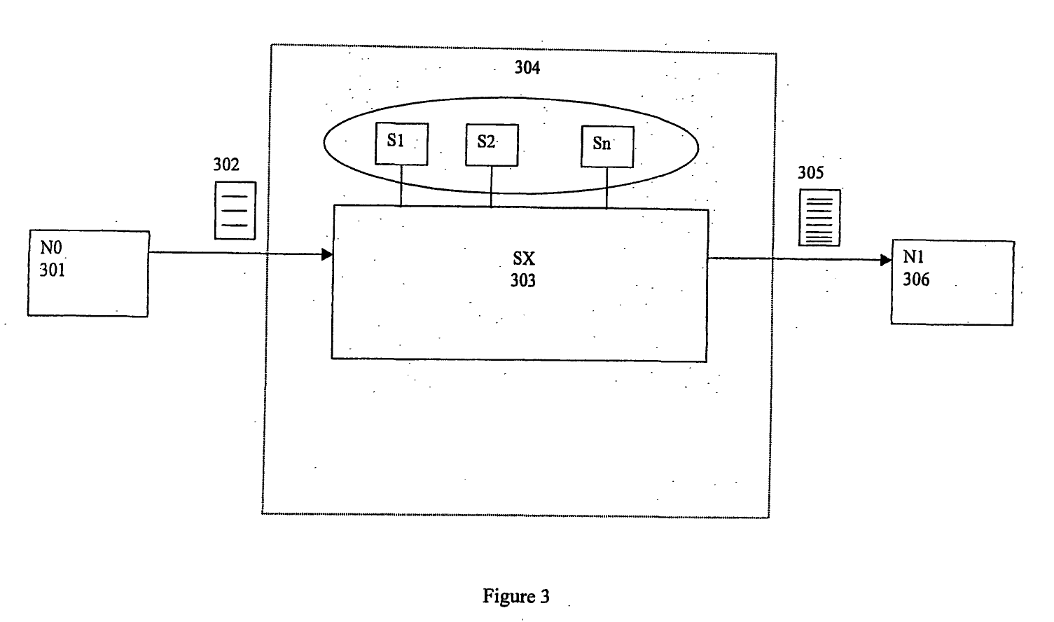

FIG. 3 shows schematically a first preferred embodiments of sender receiver node as part of a device according to the present invention;

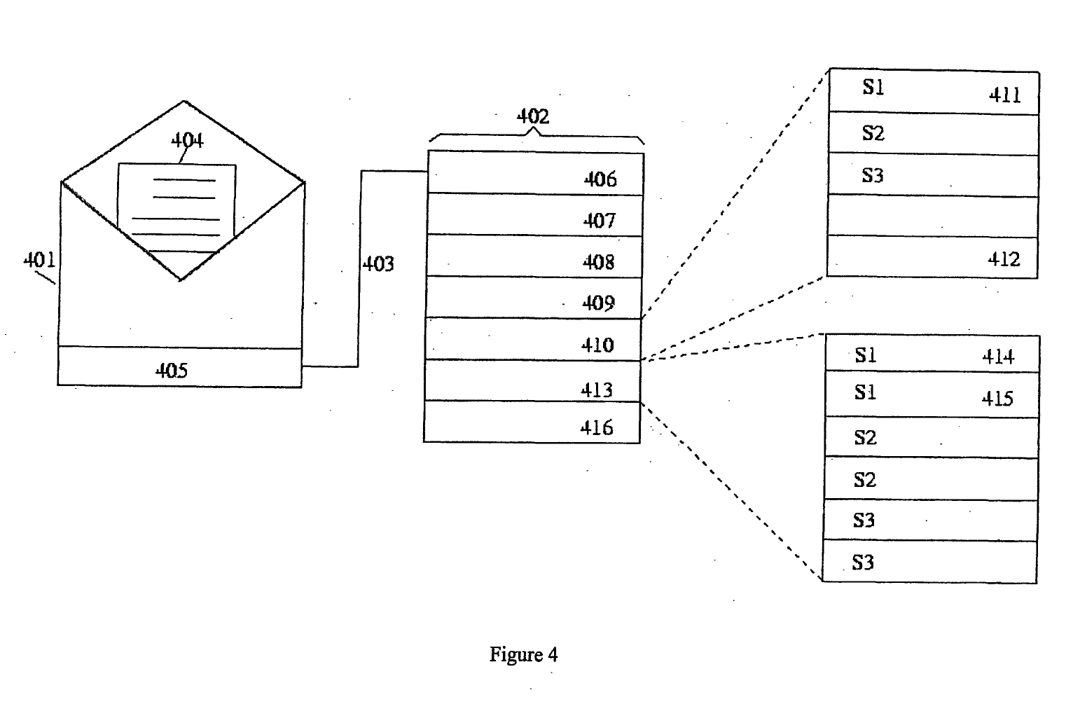

FIG. 4 shows an example type of label with his envelop

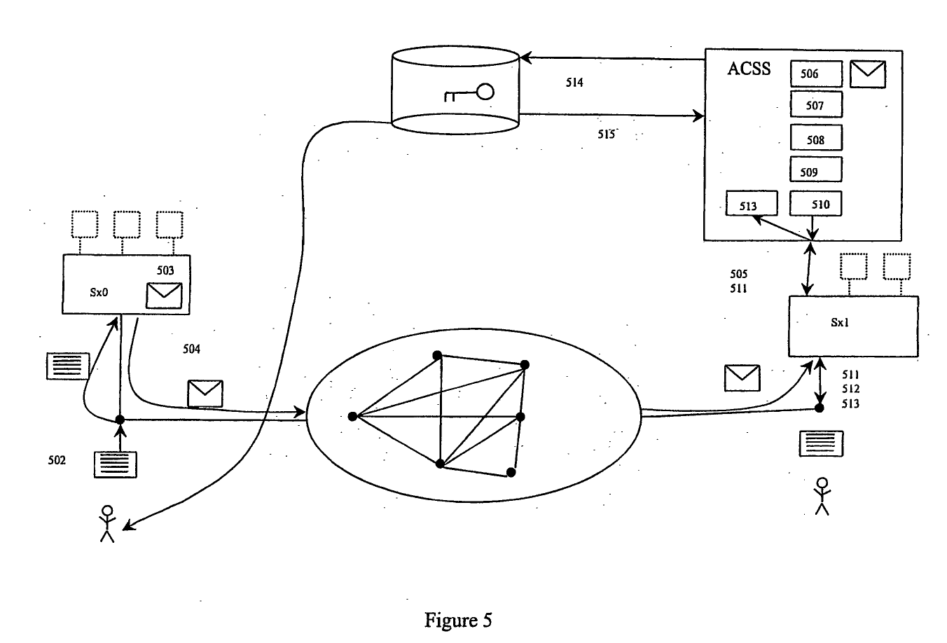

FIG. 5 shows schematically an embodiment using an access control slave server according the present invention

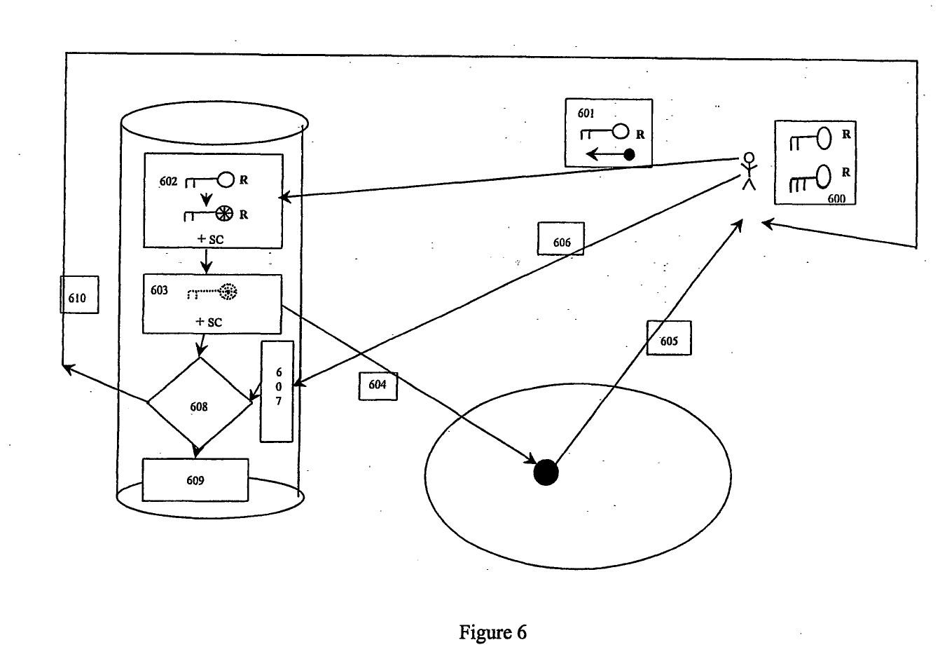

FIG. 6 shows schematically a second embodiment of a device according to the present invention; and

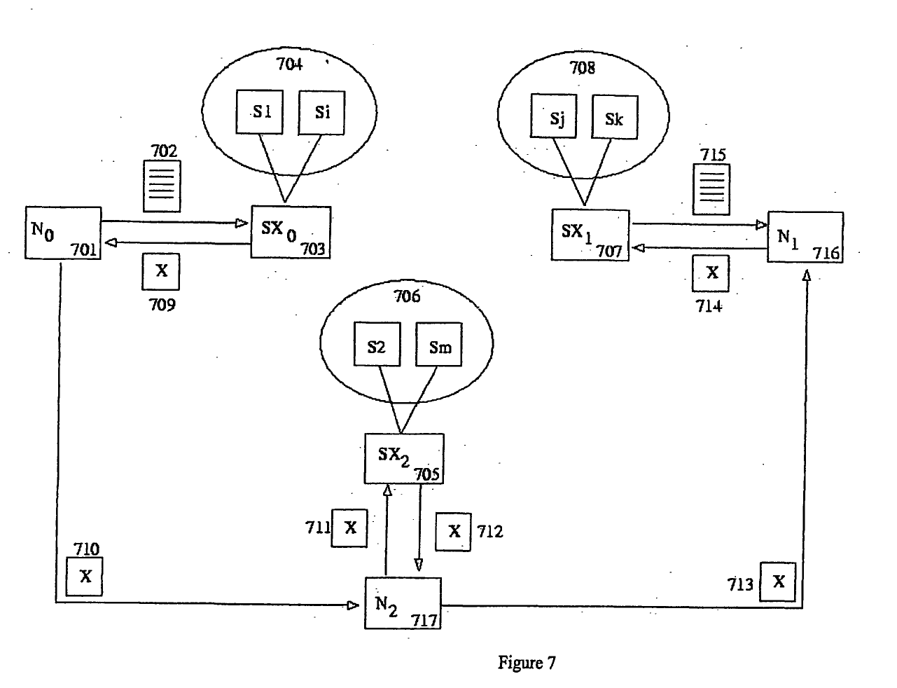

FIG. 7 shows schematically a third embodiment of a device according to the present invention.

In the drawings a same reference sign has been assigned to a same or analogous element.

Generally, a device for transmitting an electronic message comprises sender node, such as a sender computer connected to a network via an access provider. This sender node is thus linked to the network, such as the world wide web, on which is also connected a server, the latter being provided for treating the electronic messages and for transmitting these to a receiver node, such as a receiver computer, connected to the network via an access provider. This network comprises also an electronic message transfer system which is a set of electronic message transfer agents interconnected in order to be able to transfer an electronic message.

Referring to FIG. 1, a user located at a first node (101) sends an Electronic Message (EM) to another user located at another node (108), these nodes being part of a computer network (100). The sending is accomplished by using a first server which helps the user at the sender node in composing, transferring and presenting this Electronic Message to the receiver node.

The user, a real person named Alice for instance, located at the first node (101), interacts (102) with an element of a first server called an Electronic Message User Agent (103) (EMUA) which helps the sending user (101) in composing an Electronic Message (104) to be sent to the receiving user (108), named for example Bob. This composition process comprises a transforming or encapsulating of some information into a data structure transferable from one network node to another, and is often encountered on today's systems in software packages such as for example the Microsoft Outlook or the Eudora Mail end-user software. It should be noted that when an Electronic Message User Agent is used to emit Electronic Messages, it is named a Sender Electronic Message User Agent, as opposed to the Receiver Electronic Message User Agent (107), which is used to receive Electronic Messages.

After composition of this Electronic Message, the Electronic Message User Agent transmits this Electronic Message to an Electronic Message Transfer System (106), this electronic message transfer system belonging to the network. The electronic message transfer system will be responsible for transferring the Electronic Messages to the intended recipient's Electronic Message User Agent. Said Electronic Message Transfer System is generally composed of Electronic Message Transfer Agents (EMTA) (110), interconnected through network links (105). The Electronic message will be forward from one of said Electronic Message Transfer Agents to another until it reaches its final destination. After being transferred through the Electronic Message Transfer System (106), the Electronic Message (104) arrives at the Receiver's Electronic Message User Agent (107), which interacts (109) with the recipient user (108) in order to supply the EM.

As illustrating to FIG. 2, an electronic message has generally a presentation structure comprising two parts: a body part (202) and an header part (201) as illustrated in FIG. 2. The body part comprises the information which the user desires to send to the receiver. The header part comprises a set of consistently formatted Electronic Message headers, which provide key information about the Sender and Receiver(s) of this Electronic Message. This key information, unique for each node in the Electronic Message Transfer System (204, 205) is used in determining a path for the transfer of the Electronic Message in the Electronic Message Transfer System. Since this information is unique, it allows precise identification of each intermediate node and of the intended receiver's Electronic Message User Agent as well (e.g. an e-mail address). Some other optional fields (203) may also appear in the Header Part, such as the subject of this Electronic Message, the time and date of its emission, etc.

Referring to FIG. 3, a first preferred embodiment of a device according to the present invention comprises a first master server (303) linked to a series of slave servers S1, S2, . . . Sₙ generally indicated by (304). This master-slave configuration allows the master server to control a series of slave servers, each slave server being able to incorporate specific information into the electronic message Furthermore, the first server is located on a network on which there is a least one sender (301) and a receiver node (306).

When for example, a user using sender node (301) wishes to send an electronic message to a receiving party using a receiver node is (306), the user interacts with his electronic message user agent in order to compose his electronic message and to select among a list of attribute identifiers, one of more of the attribute which are to be added to the electronic message.

Many kinds of attributes can be incorporated in order to achieve a variety of services, for examples:

timestamping—service which sets a certified date on the EM, in order to help users to determine exactly at which time the EM has been sent/received,

archiving—service which keeps a backup copy of the EM for later retrieval,

access control—service which limits EM availability (see below),

non-repudiation—service which ensures identification of sender and receiver as well as return receipts,

antivirus—service which detects viruses in the electronic message and disinfects this latter,

encoding conversion—service which provides translation from one encoding to another while preserving data semantics.

Once the electronic message has been composed, the electronic message user agent adds to the electronic message a series of attribute identifiers corresponding to the attributes selected by the user sending the electronic message. In order to incorporate the selected attributes, the electronic message is transmitted by the sender node to the first server (303). The master server reads the selected attribute identifiers and identifies, based on the attribute identifiers, among the set of slave servers, this or those slave server(s) to which the electronic message will be sent in order to be processed. Then, the master server transmits said electronic message to said identified slave server(s) so that each of said identified slave servers can start the processing of the electronic message in order to add or to link said attribute to the electronic message. Each of the slave servers is provided to process a specific attribute and to process the message in such a manner that the selected attribute is incorporated into the electronic message. Thereinafter, the processed electronic message is returned from slave server to the master server if more than one attribute identifier has been selected, the electronic message can pass either from one slave server to another slave server or return each time to the master server after each slave server has incorporated his attribute. But, the person skilled in the art will clearly see that the electronic message may also pass from one to another slave server and also sometimes return to master server before the end of his processing. Once handling step is finished, the master server received the processed message and transmits this latter to the receiver node at which the receiver node is linked. According to another embodiment of the present invention, the sender and receiver node are operating within a network comprising at least one further node to which a further server, having a master-slave configuration, is connected. In this case, the first server first verifies for each selected attribute identifier, by said first master server whether there is among the slave server(s) associated with the first server, a slave server able to incorporate the attribute into said electronic message. If said first server establishes that it lacks an associated slave server able to incorporate the attribute into said electronic message, then the first server searches among said further server(s), if one of them has at least one slave server(s) able to incorporate said added attribute into said electronic message. Upon finding among said further server(s), a dedicated further server able to incorporate said added attribute into said electronic message. Then, the first server transmits to said dedicated further server the electronic message in order to be processed by a slave server of said further server which incorporates the attribute into the electronic message. If upon said searching, said first server doesn't find among said further server(s), any further server able to incorporate said attribute into said electronic message, generating a first error message, by said first server.

Furthermore, a user may require the application of a combination of more than one Electronic Message Service to incorporate an attribute to the EM.

Referring to FIG. 4, when the electronic message has been received by the first server and before transfer to one of the slave servers, the latter generates an electronic envelope (401) and a service label (402), both can be bound together by some unique information for example, a serial number (405), and can be used throughout the present method. The Electronic Envelope (EE) comprises a zone wherein the sender node's electronic message (404) will be stored. It is on the content of this Electronic Envelope that the first server performs its value-adding process. Note that an Electronic Envelope may be of any size and that it may contain multiple electronic message. As specified before, the Electronic Envelope is identified by an optional serial number (405) linked (403) to the serial number located in the service label (406).

The service label (SL) comprises a data structure having a set of fields, being labelled. Some fields can comprise information regarding the different services to be applied on the electronic message or any others information for processing the electronic message. For examples, the fields can be:

a hash field (407) comprising a first hash computed by a usual hash processing from the electronic envelope bound to this service label. Its purpose is to ensure the integrity of the electronic envelope during its transfer between separate nodes on the networks. For instance, in some embodiments of the invention, the Secure hash algorithm such as SHA-1 could serve as a secure hashing function as well as any other hash algorithm;

a billing information field (408) comprising some billing details (e.g. an account number) addressed to the slave server. The slave server may use these data for billing and/or accounting purposes;

a Keys Keyring field (409) comprising a set of public keys pertaining to the slave servers selected by the sending user. It allows the recipient node to verify the digital signatures present in the Label data structure even if the recipient node is not connectable to a certification authority;

a set of identifier fields (411) comprising information needed by the slave server to achieve the processing of the electronic envelope. Each identifier field is therefore intended for one and only one slave server. Each identifier field comprises what will be referred to as Service Identification Information (SII). Based on this Service Identification Information, each slave server is able to identify and handle the attribute identifiers;

a first digital signature field (412) comprising a first digital signature made by the sender node or a first server in order to prove authorship of this identifier fields and calculated from the preceding identifier fields. This prevents an unauthorized user from forging a fake Identifier field;

a Log Part field (413) comprising an ordered set of entries, output by slave servers when performing their respective attribute. These entries are for example: a log data field (414) comprising optional information produced by a slave server after processing the Electronic Envelope. Moreover, each Log field can comprise the same SII as the one of the slave server that produced it; and a second digital signature fields (415) comprising a second digital signature made by each slave server after processing of the Electronic Envelope in order to prove an effective receipt and processing this Electronic Envelope, and calculated starting from the Log data field;

a third digital signature (416) computed by each entity which modifies the content of this SL in order to ensure its integrity and calculated starting from the Service Label.

The integrity of the electronic envelope is preferably ensured among other things by a number of overlapping digital signatures preserved throughout the entire Electronic Message Value Adding Process.

Referring to the FIG. 5, for example, when a sender user wants to be sure that his electronic message will be received by a receiver user, the sender user selects in a list of attributes, according the present invention, a suitable attribute enabling to guarantee the transfer and sends (502) his electronic message with the selected attribute identifier to the first server (Sx0). The latter generates (503) the electronic envelope with a label and incorporates into the electronic envelope the electronic message. This electronic envelope has a structure with a predetermined form such as an XML data structure. Then, the first server verifies whether there is among his associated slave servers, a slave server able to incorporate the selected attribute into the electronic message. In this example, the first server (Sx0) establishes a lack of an associated slave server able to incorporate the selected attribute and searches among further server(s) of the secured network, if one of them has at least one slave server able to incorporate the selected attribute. In this example, the dedicated master server (Sx1), having the slave server able to incorporate the selected attribute, is located on the network along the path between the sender node and the receiver node and will hereinafter be referred to as the access control slave server. Then, the first server transmits (504) to the access control slave server the electronic envelope with his label.

Upon receipt (505) of the electronic envelope with his label by the access control slave server (ACSS), the slave server selects the public key of a second user, in this example, the public key of the receiver, the receiver having previously generated a public-private key pair. The access control slave server generates (506) then a session key and encrypts (507) the electronic message with this session key. Thereafter, the access control slave server encrypts (508) this session key with the public key of the receiver user. The access control slave server then encrypts (509) again the encrypted session key with said access control server's public key in order to obtain a twice-encrypted session key. The access control slave server integrates (510) said twice-encrypted session key in a session field of said label and sends (511) the electronic message with the twice-encrypted session key to the receiver node in order to inform the receiver user that he has received an encrypted message.

The receiver nodes, receiving such a message, sends (512) the twice-encrypted session key back to the access control server which can decrypt (513) the twice-encrypted session key with the access control slave server's private key. Thereafter, the access control server sends back (514) to the receiver the encrypted session key, in such a manner that the receiver can decrypt the encrypted session key with his private key. Upon receipt (515) of the session key, the receiver can then decrypt with the session key the electronic message.

In another embodiment of the present invention, the access control server can inform the sender user that the session key has been successfully decrypted in order to prove that the electronic message has been well delivered.

For example, and referring to the FIGS. 3 and 4, the sender user, located at the first node 301, interacts with his Electronic Message User Agent to compose an electronic message 302 destined to is a receiver user. This composition process comprises an introduction of a set of information such as the address of the sender user and the receiver user, some data and a series of attribute selected among a list of attributes. For example, the sender user can select a time stamping service, an archive service and an Antivirus service. Then, the Electronic Message User Agent introduces into the Electronic message for each selected attribute an attribute identifier, each attribute identifier being associated with one of slave servers.

Upon receipt of the electronic message the first server which generates an empty electronic envelop, comprises a zone in which the electronic message will be stored. The first server also generates the label which is provided for containing structured information regarding the treatment of the electronic message. Therefore, once the electronic envelope has been generated, the first server stores this electronic message into this electronic envelope. The electronic envelop and the label have a same serial number in such a manner that if the link between both is broken, the first server can recover both parts in order to link them again to each other.

The serial number can be created by the master server, using a collision-proof serial number generation. Moreover, according another embodiment of the present invention, this serial number can also include some reference to one or more external system and/or database(s), such as a unique identifier of an external database.

The label can also contain some information such as the billing information, the latter being for example a credit card number allowing to the first server to establish a debit note on behalf of the sender user.

The first server transfers also the selected attribute identifier in an identifier field. In the present example, the label comprises three attribute identifier fields for each selected attribute. Moreover, the label of the present invention can also comprise three digital signature fields provided for receiving a first, a second and a third digital signature. Using the selected attribute identifiers, the master server selects among the set of slave servers, this or these slave servers to which the electronic message will be sent in order to be processed. In the used example, the master server has identified three slave servers able to process each time one attribute. Before sending the electronic envelop, the first server can also generate a first hash based on the electronic message and integrate this first hash in the hash field of the label. Furthermore, the master server can introduce the public key of the selected slave server as well as his own public key in the keys keying field of the label. Then, the master server can apply his digital signature in the third digital signature field of the label. Thereafter, the first server transmits said electronic envelop and the label to the first identified slave server.

Before starting the handling process, each slave server checks that the server, be it a master or a slave, from which it received the electronic envelope and the label, has effectively digitally signed the label into the first signature field. This digital signature verification can be done by using the digital signature of the sender server having signed and his public key, located in the key keyring field. Thereafter, the serial numbers of the label and the envelop are compared, and the first slave server generates a second hash based on the receipt electronic message and combines the first and second hash.

If one of these verification processes fails, this would mean that this electronic envelope and/or label hasn't been correctly processed by the precedent server. This might indicate an attempt from an unauthorized user to modify the intended processing of the electronic message. In such a situation, the slave server can immediately take appropriate actions for example stop its processing and discard the envelop, inform the sender and/or the intended receiver, etc.

If the digital signature matches, the first slave server selects the identifier field in order to read the attribute and process the electronic message in order to incorporate the selected attribute. In the present example case, the timestamping slave server gets the current time and date from a synchronized and trusted clock and generates a report comprising an identification information identifying the slave server which produced the report. For example, the report can indicate: slave server n° XXXX. Moreover, this report can also indicate a status of the handling process, for example indicating the problem which occurred during the handling process or the time of the handling process, etc. After the report has been produced by the slave server, the latter integrates his second digital signature into the log part field in order to confirm his produced report.

Beside, the first slave server can also sign the label, for example by a new first digital signature or compute an updated first digital signature by a overlapping process. Then, this slave server generates a new first hash, based on the timestamped electronic message and transmits the electronic envelope and the label either directly to a second slave server or to the master server. When the electronic envelope and the label is sent to master server, the latter can also verify the hash by comparing between the first hash and a second hash computed by the master server.

In some embodiments of the present invention, overlapping a digital signature comprising a computing of digital signature based on a previous digital signature to which some data has been appended. For example, the master server sends the electronic message with his label service to a slave server in order to incorporate an attribute. The slave server reads, for example, the third digital signature in order to verify the validity of this digital signature. If this third digital signature is valid, then the slave server processes the electronic message and based on the third digital signature signs with his own digital signature and stores the third obtained signature in the third digital signature field.

In another embodiment of the present invention, overlapping a digital signature comprises a computing of a digital signature on some data previously signed by a server having processed the message and generated a previous digital signature on some data appended to it. For example, if this third digital signature is valid then the slave server processes the electronic message and add in the third digital signature field his own signature. Then, the slave server, based on the third digital signature fields, signs with his own digital signature in the third digital signature field.

Moreover the master server, as the slave server, can be provided for verifying the first, second and third digital signatures in order to detect a possible violation during the transfer of the electronic envelope and label.

Once receipt by the master server, this one transfers the electronic message to the second slave server which composes the hash with his second hash and determine the attribute to add to the electronic message. In the present example, the archiving slave server stocks a copy of the electronic message on a permanent non-volatile medium such a hard disk, optical disk, or another non-volatile memory and optionally can inform the sender user of the means to access to his archived message. Then, the archiving slave server can also generate a report for example archiving status OK, slave server XXYX, n° of archived filed XXXX, etc. and thereafter integrates his second digital signature to the log part field.

Then, the second slave server can sign in the same manner as described above and integrates a new first hash based on the handled electronic message. Beside, this second slave server can also transmit directly the electronic envelope and the label to the third slave server or to the master server.

As already mentioned, once the electronic envelope and the label has been receipt by the third slave server, the latter verifies the first hash and eventually verifies all the digital signatures in order to detect a possible violation. In the present example, the antivirus slave server scans the electronic envelope and the label for viruses. If a virus is found, the antivirus slave server can remove the virus from the electronic envelope and the label or even destroy the electronic message. Optionally, in case a virus is detected, the antivirus server slave could also warn the sender. If it has been established by the slave server that the electronic envelope doesn't contain any virus or that they have been removed, the antivirus slave server releases the electronic envelope and the label. The third slave server can also generate a report and integrate his second digital signature into the log part field in an analogous manner as described here before. The third slave server can also sign the label by a new first digital signature and generate a new first hash based on the handled electronic message.

Then, the third slave server transmits the envelope and the label to the master server which extracts the electronic message from the envelope and transfers the electronic message to the receiver node.

So, each server through which the electronic message flows during the process can generates a third digital signature based on the label so as to prevent any possibility of violation on the label. When a next server receives the electronic message with his linked label, this server can verify, based on the third digital signature if the label has been hacked during the transfer.

The electronic message can also be handled by others slave servers which do not belong to the first server. For example a slave is server able to perform a conversion between an A-encoded electronic message into a B-encoded electronic message, A and B being different formats for encoding the same type of documents. A respectively B being the preferred encoding the sender respectively intended recipient of the electronic message. The notion of conversion covers not only the way the document is presented in digital form but it also encompasses language conversion. For example, the converting slave server can convert for example the content of an electronic message written in English to a comparable electronic message written in French or convert, for example, an electronic message written in an electronic format into another electronic format for example to be made compatible for mobile phone or for another type of e-mail.

In the same manner, the converting slave server can also convert only a part of electronic message.

Moreover, the notion of conversion encompasses also the spelling, the grammar checks and corrections for example. The convert slave server can correct automatically the spelling and the grammar of an electronic message or transmit this electronic message to a human being who corrects the content of electronic message and returns to it the convert slave server.

As illustrating to FIG. 6, a master-slave server of the present invention can comprise a slave server able to certify a key pair of a second user in order to ensure an authentication of the second users keys. In the present case, once generated (600) by a second user, a second private-public key pair comprising a second public and one second private key as well as a second reference corresponding to said second public and second private key. The server of the second user send (601) to the certifying server a first message comprising the second public key pair with the second reference and a reference to a predetermined contact point. The reference of the key can, for example, be a series of digits and letter as for the contact point, it can for example be an e-mail address.

Upon receipt of the first message by the certifying server, the latter generates (602), firstly, based second public key part, a certifying second public key comprising a digital signature of the certifying server and secondly a secret code. Beside the certifying server encrypts (603), based on the second public key or said certifying second public key (both keys having a comparable effect) the secret code and said second certifying public key. Then, the certifying server sends (604), to the contact point indicated by the second user, a second message comprising the encrypted secret code and the encrypted certified second public key.

The second user can thus access (605) to his contact point and with his second private key decrypt the encrypted secret code and the encrypted certifying second public key.

Then, the second user sends (606) to the certifying server the secret code signed with the second private key, and the second reference. Upon receipt of this sending the certifying server decrypts (607) with the certifying second public key said secret code. So, the certifying server can compare (608) the decrypted secret code and said generated secret code. If both secret codes match then the certifying server associates (609) the certifying public key to the contact point. If not, the certifying server sends (610) to the second user a fourth error message. In this manner, the certifying server can associate a digital identity in this case a contact point with a certifying second public key.

Moreover, before the certifying server receives the first message, the second user could have interacted with a predetermined party identified by said server such as a bank, a mutual insurance. This predetermined party has thus precisely identified this second user, this user receives for example a credit card number, a reference number, a accounting number, or a social security number, etc.

In order to include a third party in the certification process, the second user can additionally include in the first message a certified digital data block such as a credit card number, a social security number or also a scanned picture of his identity card, etc. Upon receipt of the first message, the certifying server can authenticate the certified digital datablock, by interacting with the third entity which has delivered the datablock. For example, the certifying server can request the bank to debit the account number of certain sum on behalf of the second user if the bank accepts this means that the account belongs to the second user. If not then the datablock is not valid. So, at the end of the certification process, the certifying server can also associate the certifying public key and the contact point with said certified digital identity, here, the credit card number.

An alternative to this method for certifying could be a method where a third user generates a third public-private key comprising a third public key and third private key as well as a third reference corresponding to the public-private key pairs. Then, the third user can send to the certifying server a first message comprising the third public key with his third reference and a third reference to a predetermined contact point.

Receiving the first message, the certifying server generates firstly based on the third public key, a certified third public key, comprising a digital signature of the certifying server, and secondly a network address. The certifying server also creates a link between the third reference and the certifying third public key. Thereafter, the certifying server encrypts, based on the third public key or said certifying third public key, the network address and the certified third public key.

Then, the certifying server sends a second message comprising the encrypted network address and the encrypted certifying third public key. The third user accesses to the contact point and can decrypt with has third private key the encrypted network address and the encrypted certifying third public key.

Thereafter the third user can address the network address, in order to prove that the certification process has been well performed. Therefore, the certifying server can associate the certified third public key to the contact point. Beside, the certifying server sends to the third user a fourth error message if the third user can't access the network address.

Moreover a slave server could be provided for performing a certified key pair revocation. So when a key pair is generated, the user appoints a certificated authority, such as the certifying slave server or another certified slave-server, as the designated revoker for the key able to invalidate the key pair. When the user wishes to revoke his key pair, for example because the user has lost access to his private key, the user sends to the certificate authority his public key. Upon the public key receipt by the certificated authority, the latter generates a revocation network address comprising a block of data ordering the certificated authority to start the revocation. This revocation network address is then sent to a predetermined contact point, for example the e-mail address of the user. The user, accessing to the contact point, can access the resource pointed by this revocation network address. By doing this, the data bloc is sent back to the certificated authority which in turn computes a revocation signature on the user's public key.

The certificated authority can then send to the contact point associated with the public key, a message containing a revoked copy of this public key. If the user returns to certificated authority this revoked copy of this public key, then the certificated authority publishes the revoked public key as well as the data comprising the revoked public key.

Beside, the master-slave set-up of the present invention can also be provided with a slave server able to store the private keys of the users. So, a fourth user, having generated previously a fourth private-public key pair, can generate a random salt (an arbitrary amount of bits, for example 80 bit long), choose an arbitrary puzzle size n (an arbitrary amount of bits, for example 100 bit long) and generate based on the puzzle size, a random puzzle of n bits lenght. The fourth user can, based on a passphrase (an arbitrary amount of characters), the random salt and the random puzzle, generate a secure hash and encrypt the fourth private key with this secure hash. The fourth user can send the encrypted private key, the random salt and the arbitrary puzzle size to the private key storage server in order to store the private key, the random salt and the arbitrary puzzle size. If the fourth user desires to take back his encrypted private key from the private key storage slave server, the fourth user requests to the private key storage slave server the encrypted private key, the random salt and the arbitrary puzzle size so that the private key storage slave server can send the encrypted private key, the random salt and the arbitrary puzzle size to the fourth user.

So the fourth user can iterate for every possible choice of a puzzle, having a puzzle size n, and generate for each iteration a hash, based on the passphrase, the random salt and the choosed puzzle. For each generated hash try to decrypt the private key until the correct puzzle has been found.

Moreover an improvement could be the encryption of the private key preceded by a predetermined code to help the recognition of the correct puzzle and hash. Both the private key and the predetermined code are encrypted together.

It shall be obvious to the person skilled in the art that this process makes it harder for an attacker to retrieve the Private Key. When the passphrase is known, the process of unsealing the encrypted private key can be handled in a reasonable time. With carefully chosen random salt length and the arbitrary puzzle size, the processing time required for trying an arbitrarily huge amount of passphrases (attack known to the person skilled in the art as “brute force”) becomes dissuasive.

As illustrated in FIG. 7, the device for transmitting an electronic message, according to the present invention, comprises three nodes associated respectively to a sender, a second server and a receiver, these three nodes being linked together via a network. Beside, the sender node, second server node and receiver node are connected respectively to a first server, a second server and a receiver node.

Moreover, it could also be possible to have a series of other servers between the sender node and the receiver node, this other servers having a master slave configuration, each server being connected to the network by his own node.

In the shown example, the sender node N₀ desires to send (701) an Electronic Message (EM) (702) to the receiver node N₁ (716) while adding to this electronic message (702) a predetermined number of selected attributes. In this example, the selected attributes can be added by three set of identified slave servers (704, 706, 708) located on a first, second and third master-slave server SX₀ (703), SX₁ (707) and SX₂ (705), these latter being also linked to respectively a sender node N₀ (701), a node N₁ (716) and receiver node N₂ (717).

For adding these selected attributes, the Electronic Message (702) is first transmitted by the sender node (701) to the core entity of the present invention, the first server SX₀ (703). This first server (703) processes this Electronic Message by passing the latter through the first set of slave servers (704) in order to incorporate a part of attributes selected by the sender. In this example, the first server doesn't comprise all slave servers able to incorporate all selected attributes. The first server is thus forced to search on the network others server having the slave server able to add the other parts of attributes. Once finding among the servers of the network, the dedicated server, the first server generates the Electronic Envelope and transmits the latter with the electronic message (709) to its Service Exchanger Electronic Message Sender in order to transfer (710) this Electronic Envelope to the node corresponding to one of the dedicated server, which contains the required slave server(s).

In this case, this transfer is ensured by the sender node which is a part of an electronic message handling system.

At the third node (717), this electronic with the electronic message is transmitted (711) to the second server SX₂ (705), which provides other required attribute (706). This server will process this electronic message by passing this latter to its identified slave server in order to incorporates a second set of attributes. Then, the second server transfer the electronic envelope with the electronic message and his label to its service exchanger electronic message in order to send (712) this electronic envelope to the receiver node, which contains the lacking slave server able to incorporate the latter set of attribute(s).

This transfer is ensured by the second server node (717), as a part of an electronic message handling system, which is able to forward (713) this electronic message among its electronic message transfer system.

At the receiver node, this service exchanger electronic message is transmitted (714) to the third (receiver) server SX, (707), which can incorporate(708) the latest required attribute(s) and which, after processing, transmits (715) a finally processed electronic message to this receiver node (716).

Additionally, if the receiver user can't directly access to the sent electronic message, for example because the receiver hasn't e-mail address or he can't access to his receiver node. In this example, the first server stores the electronic message. Then, the master server or one of his associated slave server generates via a network address generating member a network address and assigns this network address to the sent electronic message to be delivery. For example, the first server could generate a web page based on the electronic message to be delivery, this web page having the generated network address such a URL. Beside, the first server informs the receiver user that he has received an electronic message from the sender user and that he must point the generated network address to have access to this electronic message. Once pointed, the webbrowser find the generated network address and displays the electronic message.

Moreover, the generated network address can be also encrypted by the first server, upon receipt, the receiver user must first decrypted before to point this address network.

According another embodiment of the present invention, a server or one of this associated slave server generates an URL destined to the receiver user. After, the server stop the processing and waits for the user's reaction. When the receiver user point this URL, the server resumes the processing.

In order to improve the security level, the present invention can comprise a third node associated to a first user and an authorized server, both belonging to a network.

The authorized server is a server predetermined by the first server operator.

Before transmitting the processed electronic message to the receiver node the authorized server selects, for example in a list of user, a first user having a first private-public key. Then, this authorized server generates a session key and encrypts the processed electronic 15 message with the session key. After, this authorized server encrypts the session key with the public key of the first user and places the encrypted session key in a session field of the label. Then, the authorized server send the electronic message and the label to the receiver node. The receiver node or user, being not able to decrypt the session key, request the first private key of the first user for decrypting the session key.

Upon the private key of the first user received by the receiver node, this latter can decrypt first the session key with the private key and then, decrypts the processed electronic message with the session key.

1. A method for transmitting an electronic message from a sender node to at least one receiver node, said method comprising:
forming an electronic message at said sender node;
adding an attribute to said electronic message;
sending said electronic message from said sender node to a first server;
processing said electronic message in order to form a processed electronic message;
transmitting said processed electronic message to said receiver node (s);
characterized in that said processing comprises a processing by said first server which has a master-slave configuration and comprises a set of slave servers, each slave server being provided for processing a predetermined attribute to said electronic message, and wherein adding said attribute comprises a selection of at least one attribute identifier among a series of attribute identifiers, each attribute identifier of said series being associated with one of said slave servers, and wherein said processing comprises:
(i) an identifying step comprising: identifying among said set of slave servers, by said master server and based on said attribute identifier, this or those slave server (s) to which said electronic message will be sent in order to be processed; and
(ii) a handling step comprising:
(ii-1) transmitting said electronic message from said master server to said identified slave server (s);
(ii-2) processing said electronic message by each of said identified slave servers in order to incorporate said attribute into said electronic message; (ii-3) transmitting said processed electronic message from the slave server to the master server.

2. A method as claimed in claim 1 characterized in that said sender and receiver node are operating within a network comprising at least one further node to which a further server, having a master-slave configuration, is connected, and wherein said identifying step comprises:
verifying for each selected attribute identifier, by said first master server whether there is among the slave server (s) associated with the first server, a slave server able to incorporate said added attribute into said electronic message,
if said first server establishes that it lacks an associated slave server able to incorporate said added attribute into said electronic message, searching among said further server (s), if one of them has at least one slave server (s) able to incorporate said added attribute into said electronic message; and upon finding among said further server (s), a dedicated further server able to incorporate said added attribute into said electronic message;
transmitting, by said first server to said dedicated further server;
processing said electronic message by a slave server of said further server in order to incorporate said attribute into said electronic message; and
if upon said searching, said first server doesn't find among said further server (s), any further server able to incorporate said attribute into said electronic message, generating a first error message, by said first server.

3. A method as claimed in claim 1, characterized in that after transmitting said electronic message to said receiver node, said electronic message is received and handled further by said receiver node having a receiver server with a master-slave configuration.

4. A method as claimed in claim 1, characterized in that said method further comprises, upon receipt of said electronic message by said first server:
forming, by said first master server, a label having a data structure comprising a set of fields, each field having each time a predetermined length, said set of fields comprising an identifier field;
selecting said identifier field within said label
integrating, by said first master server, said selected attribute identifier within said identifier field;
linking said label to said electronic message.

5. A method as claimed in claim 4, characterized in that said method further comprises the generation of a first digital signature on the basis of a content of said identifier field and the integration of said first digital signature into said identifier field.

6. A method as claimed in claim 4, characterized in that said set of fields also comprises a hash field and wherein said method further comprises:
forming, before transmitting said electronic message to said identified slave server, a first hash computed on the basis of said electronic message
selecting said hash field within said label and integrating said first hash in said selected hash field; and
before said handling step:
generating a second hash based on said electronic message received by said identified slave server and comparing said first and second hash;
matching said first and second hash by said master server,
generating a second error message by said master server if said comparison results is a non-matching of said first and second hash.

7. A method as claimed in claim 4, characterized in that said set of fields also comprises a log field and wherein said method further comprises, before transmitting said processed electronic message from said first master server to said identified slave server:
selecting, by said master server, said log field within said label;
generating a report comprising an identification information indicating said identified slave server which produced said report;
generating a second digital signature based a private key of said identified slave server;
integrating in said log field, said report and said second digital signature by said identified slave server.

8. A method as claimed in claim 7, characterized in that said set of fields further comprises a key keyring field provided for storing a set of public keys in such a manner that each server is able to verify said second digital signature generated on the basis of said private key of said identified slave server (s), and wherein said method further comprises, before said handling:
selecting said key keyring field within said label;
integrating a public key of said identified slave server (s), in said key keyring field;
verifying, by a least one slave server, said second digital signature which is previously generated by slave server, and generating a third error message if said at least one of slave server is not able to verify said second digital signature.

9. A method as claimed in claim 7, characterized in that said set of field also comprises a third signature field and wherein said method further comprises:
generating, by each server which modifies said electronic message, a third digital signature, based on the content of the third signature field.

10. A method as claimed in claim 4, characterized in that said set of fields also comprises a serial number field and wherein said method further comprises, before forming said label by said first server:
forming, by said first server, an envelop having a serial number;
introducing said electronic message into said envelop;
linking said label to said envelop;
integrating, by said first server and in said serial number field of said label, a copy of said serial number;
extracting, by said identified slave server and before incorporating said attribute, said electronic message from said envelop;
introducing by said identified slave server said electronic message into said envelop, after said identified slave server has incorporated said attribute.

11. A method as claimed in claim 1, characterized in that said sender and receiver node belong to a network comprising a network address generator, said method further comprises:
generating a network address by said network address generator;
assigning said electronic message to said network address;
sending by said network address generator, said network address to said receiver node; and
pointing by said receiver node said network address so that said receiver node has access to said electronic message.

12. A method as claimed in claim 11, characterized in that said assigned network address comprises a data block verified by said first server in order to access to said electronic message.

13. A method as claimed in claim 12, characterized in that said data block is encrypted and/or signed by a authenticated server.

14. A method as claimed in claim 4, characterized in that said set of fields also comprises a session key field, and wherein a predetermined server, belonging to a network, is an access control slave server having a public-private key pair, and wherein said method further comprises:
before transmitting said processed electronic message to said receiver node(s):
selecting by said access control slave server a public key of said first user having a first private-public key;
generating by said access control slave server a session key and encrypting said electronic message with said session key;
encrypting said session key with said first public key of said first user;
encrypting said encrypted session key with said access control slave server's public key in order to obtain a twice-encrypted session key;
placing said twice-encrypted session key in a session field of said label
sending said electronic message to said first user node;
sending, by said first user node, to said access control slave server said twice-encrypted session key;
decrypting by said access control slave server said twice-encrypted session key with said access control slave server's private key;
sending, by said access control slave server, to said first user said encrypted session key;
decrypting by said first user with said first user's private key said encrypted session key;
decrypting said electronic message with said decrypted session key.

15. A method as claimed in claim 14, characterized in that said method further comprises,
generating by a second user a second private-public key pair comprising a second public and second private key as well as a second reference corresponding to said second public and second private key
sending, by said second user to a certifying server, a first message comprising said second public key with said second reference and a reference to a predetermined contact point;
receiving by said certifying server said first message;
generating by said certifying server on basis of said second public key a certified second public key comprising a digital signature of said certifying server and a secret code;
assigning said second reference to said certified second public key;
encrypting by said certifying server, based on said second public key or said certified second public key said secret code and said second certified public key;
sending to said contact point a second message comprising said encrypted secret code and said encrypted certified second public key;
accessing said contact point by said second user and decrypting with his second private key said encrypted secret code and said encrypted certified second public key;
sending by said second user to said certifying server said secret code signed with said second private key and said second reference;
decrypting said secret code by said certifying server with said certified second public key;
comparing said decrypted secret code and said generated secret code and if both matches associating by said certifying server said certifying public key to said contact point
sending by said server to said second user a fourth error message in case of non-matching.

16. A method as claimed in claim 15, characterized in that said method further comprises: before receiving said message by said certifying server
supplying a certified digital data block furnished by a predetermined party identified by said first server and adding said certified digital data block to said message;
after said message has been received by said certifying server
authenticating by said certifying server said certified digital datablock;
comparing by said certifying server said decrypted secret code and said generated secret code, and
assigning by said certifying server said certifying public key and said contact point to said certified digital identity if both are matching and upon non-matching, sending a fifth error message to said third user.

17. A method as claimed in claim 15, characterized in that said method further comprises,
generating by a third user a third public-private key pair comprising a third public and third private key as well as a third reference corresponding to said third public and private key pair;
sending by said third user to a certifying server a first message comprising said third public key with his third reference and a third reference to a predetermined contact point;
receiving by said certifying server said message;
generating on basis of said third public key a certified third public key comprising a digital signature of said certifying server and a network address
linking said third reference with said certified third public key;
encrypting by a slave server based on said third public key or said certified third public key said network address and said certifying third public key;
sending to said contact point a second message comprising said encrypted network address and said encrypted certified third public key;
accessing by said third user with his third private key said contact point and decrypting said encrypted network address and said encrypted certified third public key;
pointing by said third user said network address in order to request to certifying server to assign said certified third public key to said contact point, if said network address is not pointed by said third user after a period of time, a slave server sends to said third user a first fourth message.

18. A method as claimed in claim 17, characterized in that said method further comprises:
sending by a user who wishes to revoke his public key a revocation message to said certifying server;
receiving by said certifying server, said revocation message:
generating by said certifying server a revocation network address comprising data requesting said certifying server to revoke said public key;
sending by said certifying server to said contact point said revocation network address;
requesting by said user said network address so as to order said certifying server to revoke said public key;
revoking by said certifying server said public key.

19. A method as claimed in claim 18, characterized in that said method further comprises,
upon revoking by said certifying server said public key:
sending said revoked public key to said user;
if said user returns to certifying server said revoked public key then said certifying server publishes said revoked public key.

20. A method as claimed in claim 18, characterized in that said method further comprises, during said generation of a revocation network address by said certifying server, an addition by said certifying server into said network address of data indicating that said public key has been revoked.

21. A method as claimed in claim 17, characterized in that a predetermined server belonging to a network is assigned as an private key storage slave server, and wherein said method further comprises:
generating by a fourth user a fourth private-public key pair;
generating by said fourth user a passphrase, a random salt and a random puzzle with arbitrary puzzle size;
generating by said fourth user a secure hash, based on said passphrase, said random salt and said random puzzle;
encrypting said fourth private key by using said secure hash;
storing said encrypted fourth private key on said private key storage slave server together with said random salt and said puzzle size;
if-the fourth user desires to take back his encrypted private key from said private key storage slave server, then said method comprises:
requesting by said fourth user to said private key storage slave server said encrypted private key, said random salt, and said predetermined puzzle size;
sending by said private key storage slave server to said fourth user said private key, said random salt, and said puzzle size;
iterating for every possible choice of a puzzle, having said puzzle size, and generating for each iteration a hash, based on said passphrase, said random salt and said choosed puzzle, for each generated hash trying to decrypt said private key until the correct puzzle has been found.

22. A device for transmitting an electronic message from a sender node to at least one receiver node, said device comprising a sender node to which is assigned a first server carrying at least one sequence of instructions for transmitting said electronic message, said first server being able to add based on an attribute identifier, an attribute to said electronic message characterized in that said first server has a masterslave configuration comprising a set of slave servers, each slave server being provided for processing a predetermined attribute to said electronic message, each attribute corresponding each time to an attribute identifier pre-selected among a series of attribute identifiers, each attribute identifier of said series being associated with one of said slave servers, said master being provided for identifying based on said selected attribute identifier (s) among said set of slave servers to which said electronic message will be sent in order to be processed and for transmitting to this or those identified slave server (s) said electronic message, each of said identified slave servers being provided for processing said electronic message in order to incorporate said attribute into said electronic message and for transmitting said processed electronic message to said master server.

23. A device as claimed in claim 22, characterized in that said sender and receiver node are connected to a network comprising at least one further node to which a further server, having a master-slave configuration, is assigned and that said first master server is provided for verifying for each attribute identifier whether there is among his associated slave server (s), a slave server able to incorporate said attribute into said electronic message, and provided for searching, if said first server establishes that it lacks an associated slave server able to incorporate said attribute into said electronic message, among said further server (s), if one of them has at least one slave server (s) able to incorporate said attribute into said electronic message; said first master server being provided for transmitting said electronic message to a dedicated further server able to incorporate said attribute into said electronic message, and provided for generating a first error message if said first server doesn't find among said further server (s), any further server able to incorporate said attribute into said electronic message.

24. A device as claimed in claim 22, characterized in that said receiver node has a receiver server with a master-slave configuration provided for receiving and handling said electronic message.
